(19) United States
(12) Patent Application Publication
(10) Pub. No.: US 2004/0027419 A1
(43) Pub. Date: Feb. 12, 2004

(54) Dispensing nozzle

(76) Inventors: Per Ove Ohman, Uppsala (SE); Patrik Hollman, Uppsala (SE)

Correspondence Address: YOUNG & THOMPSON, 745 SOUTH 23RD STREET 2ND FLOOR, ARLINGTON, VA, 22202

(21) Appl. No.: 10/380,539

(22) PCT Filed: Sep. 14, 2001
(86) PCT No.: PCT/SE01/01968

(30) Foreign Application Priority Data
Sep. 15, 2000 (SE) 0003293-8

(51) Int. Cl. B41J 2/14; B41J 2/16

(52) U.S. Cl. 347/47

(57) ABSTRACT

Dispensing nozzle (15), comprising an essentially flat base member (17) having two essentially parallel surfaces. At least one fluid channel (16) is provided therein with an inlet opening and an outlet opening. The channel is oriented substantially perpendicularly in relation to the general extension of the base member (15). A surface surrounding at least one of said openings has a high wetting angle for the fluid to be dispensed.

The present invention relates to a dispensing nozzle for dispensing minute fluid volumes, a method for making the dispensing nozzle, a pipette tip comprising the dispensing nozzle, a pipette comprising the pipette tip, and a method for dispensing a fluid by means of an inventive pipette member.

### BACKGROUND OF THE INVENTION

It has since long been desirous, in particular in biological and bio-chemical applications, to be able to dispense very small volumes of fluid, ranging from microlitres (II) and downwards in order to minimise costs and improve efficiency, and to perform this dispensation in a controlled manner. A number of techniques have been employed to reach the desired results.

One such technique consists in using pipettes having a space for holding a fluid into which a desired amount of fluid is introduced using an adjustable piston pump or a similar device, by means of which the fluid is then pumped out into the desired location, such as an analysis well on a micro-titre plate.

The problem with such devices is their inaccuracy. When working in the lower range of the micro-litre scale there are obvious disadvantages pertaining to volume inaccuracy in using such devices. Since the pump has a mechanism actuated by hand, it is difficult to obtain the desired degree of accuracy in dispensing such small volumes. Since the pump mechanism is used for both collecting the fluid volume to be dispensed, and for dispensing the fluid volume, this constitutes another source of error, since it is difficult to repeat the same exact movement with a conventional pump mechanism, even if the pump stroke is set, and especially so since the movement is reversed when the fluid volume is to be pumped out of the pipette.

Another source of dispensing inaccuracy is related to the pipette tip. A conventional pipette tip is comprised of a conical plastic body having an internal volume that is filled with the fluid to be dispensed. Since the opening of the pipette tip is made in the plastic material of the pipette tip, it is not as well defined as it would need to be in order for achieving the desired degree of accuracy. Further, if the plastic material has a relatively low wetting angle, the deviation can be quite important, especially considering dispensing of volumes of e.g. a few micro-litres. Some of the fluid may adhere to the pipette tip, and since the volume is very small, this could mean that as much as half the volume to be dispensed could adhere to the area of the tip around the opening.

To remedy this problem, it is known to provide the underside of dispensing members with a coating having a high wetting angle, to prevent the fluid from adhering to the dispensing member. It would, however, be desirous to provide a dispensing nozzle where such properties could be modified to fill the needs of a certain application.

A related problem is that of delivery precision. Since the volumes are very small, the surface tension of fluid adhering to the pipette tip may cause the dispensed fluid to deviate from the desired direction of dispensing. This may be as serious a problem as the volume inaccuracy. Furthermore, the conventional techniques for manufacturing nozzles suitable for dispensing minute volumes of fluid have a serious drawback, in that the plating techniques used only allow for the use of a relatively limited number of materials. This has consequences for numerous applications where it is necessary to provide some areas of the nozzle with certain surface properties, in that such characteristics have to be provided separately. Such techniques are further relatively expensive.

For some applications, for example inkjet printers, it is sometimes a problem that the nozzles are damaged by being contacted by the paper being printed. If the outlet opening of the nozzle is damaged by contact with the paper, this may render the nozzle unfit for use, and replacement of the nozzle is required to secure a good function of the printer device.

Finally, many of the more efficient and accurate prior art techniques for dispensing small fluid volumes are quite complicated, and thus very expensive. This constitutes a problem in many cases, since it is often desirous to keep the costs as low as possible for many types of analyses for the purpose of competitiveness, and for making more types of analyses available to more users at a reasonable cost.

### SUMMARY OF THE INVENTION

Thus, there is a need for improved dispensing nozzles having easily modifiable characteristics regarding the wetting angle for the dispensed fluid that are inexpensive to manufacture, and allow for a more rational and accurate dispensing of fluids in relation with e.g. a micro-titre plate, or other situations where very small volumes, as small as nanolitres, have to be dispensed with high accuracy and also with a high degree of efficiency, and which are applicable in a number of different fields, for instance as nozzles for pipette tips.

There also exists a need for a more cost efficient method of dispensing small volumes of fluid using such an inexpensive dispensing nozzle.

The above problem, and other related problems, are solved by means of the present invention.

According to a first aspect of the present invention, there is provided a dispensing nozzle as defined in the characterising part of claim 1.

According to a second aspect there is provided a method for manufacturing dispensing nozzles as defined in the characterising part of claim 10.

According to a third aspect of the present invention, there is provided a dispensing member for a pipette as defined in the characterising part of claim 24.

According to fourth aspect of the present invention, there is provided a dispenser as defined in the characterising part of claim 25.

According to a fifth aspect of the present invention there is provided a method for dispensing minute volumes of fluid as defined in the characterising part of claim 30.

Further advantages and features of the present invention are apparent from the dependent claims.

### BRIEF DESCRIPTION OF THE DRAWINGS

Embodiments of the different aspects of the invention will now be described in closer detail, reference being made to the appended drawings, in which:

FIG. 1 is a perspective view of dispensing means for a pipette;

FIG. 2a is a plan view of a nozzle for the dispensing means in FIG. 1;

FIG. 2b is a cross section of the nozzle in FIG. 1 along the line II-II;

FIGS. 3a and 3b show an alternative design of a nozzle according to the present invention in a plan view and cross section, respectively;

FIGS. 4a and 4b show two alternative designs for a nozzle according to the present invention in plan view and cross section, respectively;

FIG. 5a is a perspective view of a mould according to one aspect of the present invention;

FIG. 5b is a perspective view of a mould according to second embodiment of this aspect of the present invention;

FIG. 6a; and

FIG. 6b

### DETAILED DESCRIPTION OF PREFERRED EMBODIMENTS

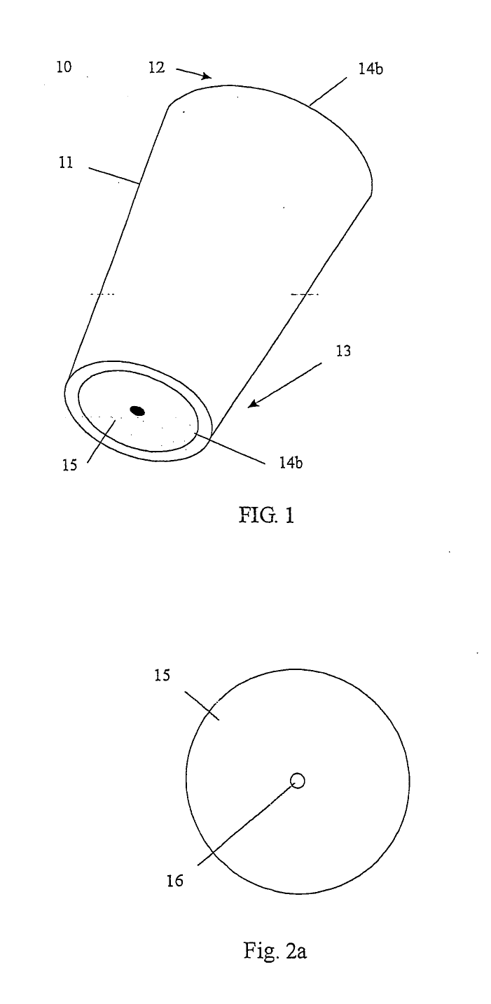

First with reference to FIG. 1, there is shown an embodiment of a dispensing device according to the present invention for use as a tip for a pipette, generally designated by the reference numeral 10. Said device comprises a body portion 11 having a first end 12 and a second end 13, and an internal conduit 14 having a first opening 14a at the first end 12 of the body portion 11, and a second opening 14b at the second end 13 of the body portion 11. The first end 12 comprises a structure allowing the dispensing means to be mounted to a pipette (not shown), such as conventional snap lock means or the like. Examples of this structure, including the pipette are not shown in the figures, since this is well known to the artisan. The first opening 14a of the internal conduit provides fluid communication with a channel of the pipette when mounted thereon, and the second opening 14b is open to the outside when mounted on the pipette. The second opening 14b of the second end 13 of the body portion includes means for mounting a dispensing nozzle 15 according to the present invention. This specific embodiment will be described in more detail below.

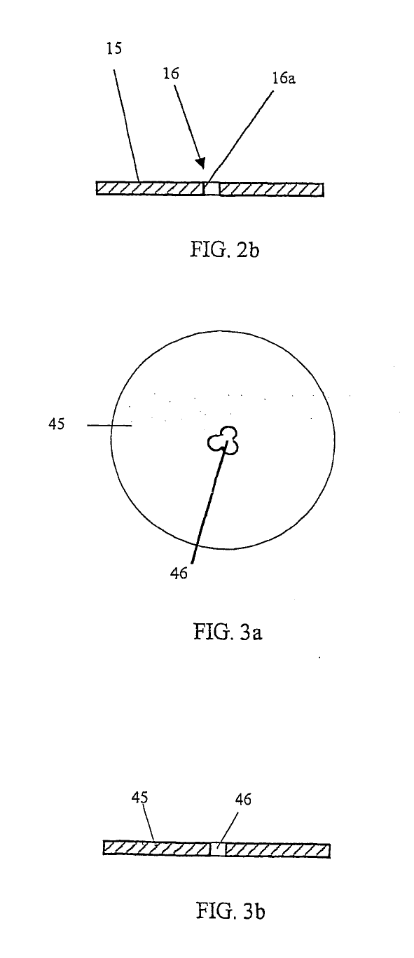

The dispensing nozzle 15 according to the embodiments of the present invention shown in FIGS. 2-4, comprises a base member 17 having the shape of a round washer, and a fluid channel 16 provided centrally in the washer. The fluid channel 16 has a diameter ranging from approximately 20 μm and upwards, for instance up to approximately 200 μm. The inner surface 16a of the fluid channel 16 has high wettability, so as to make a fluid which is introduced in the channel 16 adhere to the inner surface 16a thereof. Some of the surfaces surrounding the openings of the fluid channel 16 may have low wettability. In one embodiment of the dispensing nozzle, the bottom surface has low wettability, which is provided either by suitable selection of a material for the bottom surface having such intrinsic properties, or by a surface coating provided in a separate step. One solution consists in sputtering a thin layer of silver or gold on the surface to be treated, and subsequently letting this surface react with octadecanthiol dissolved in ethanol. This treatment forms a thin layer of molecules on the silver or gold surface that gives a high wetting angle for water.

The reasons for providing such characteristics are the following. When dispensing minute fluid volumes it is of great importance to ensure that the entire volume to be dispensed, and which travels through the fluid channel actually leaves the outlet opening of the dispensing nozzle. When dealing with volumes in the range of nanolitres, or even picolitres, it is therefore necessary to ensure that no fluid remains on a surface surrounding the opening of the dispensing nozzle which easily happens when dispensing fluid from a nozzle opening. If, however, the bottom surface surrounding the outlet opening has low wettability, this is avoided, wherefore it is desired to provide the bottom surface with such properties to, if the bottom surface material itself does not possess this property. In the present specification and in the claims, low wettability shall be understood as a wetting angle of 90° or more for the fluid to be dispensed. Since the wettability of a surface is specific to an individual fluid, it may be necessary to provide one and the same nozzle material with different surface coating in order to obtain the same wettability for different fluids.

In some applications it may be desirable to have different wetting angles on different areas of the nozzle. For example, the fluid channel itself may have a portion with low wettability, e.g. a lower portion near the outlet opening, and a portion with high wettability, e.g. in the upper portion adjacent to the inlet opening. Similarly, the upper and lower surfaces may both be provided with have only low wettability, or entirely high wettability, or display a combination of these properties in different zones, depending on the specific needs of the specific application.

Further, the shape of the fluid channel may be varied according to certain principles. The basic shape of the fluid channel, which is shown in the figures, is that with a cylindrical cross section. For some applications it may, however, be advantageous to provide a fluid channel having a different cross section. Since the pressure which is necessary to break the surface tension of the fluid at the outlet opening of the fluid channel increases when the ratio between the circumference of the channel and its cross sectional surface area increases, it may be desirable to provide a fluid channel having a cross sectional shape which is different from the cylindrical shape, e.g. elliptic, quadratic or star-shaped, or any other desired shape, in order to increase the circumference/area ratio from that of the circular cross section.

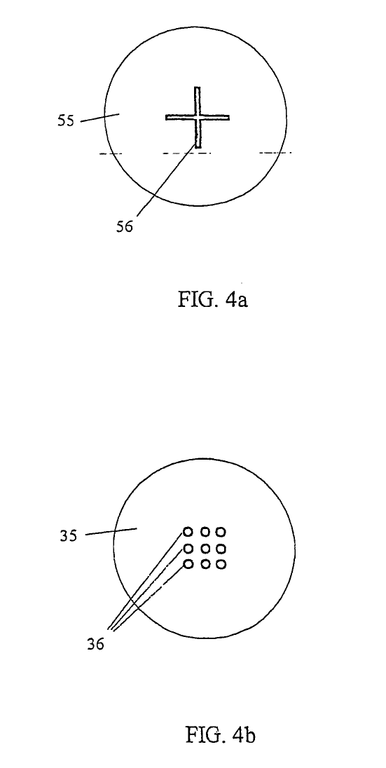

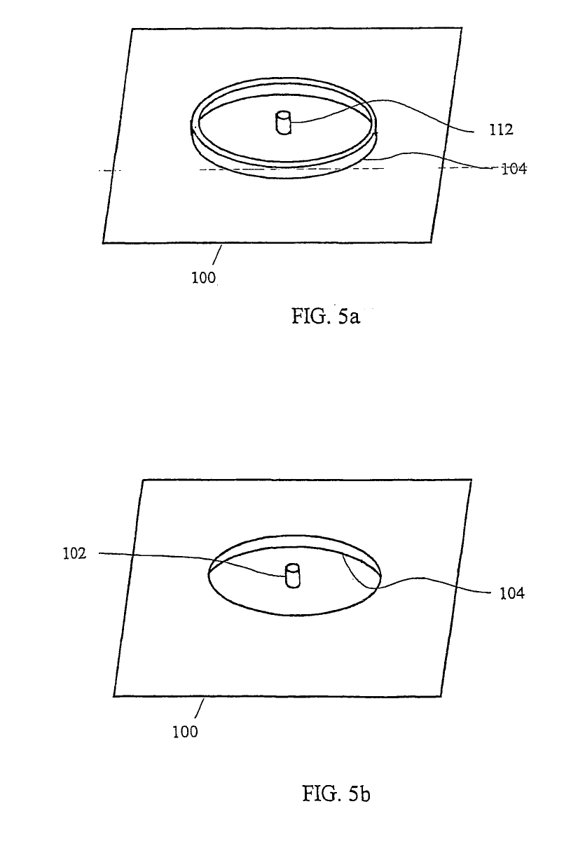

According to another embodiment (FIG. 4b) of the inventive dispensing nozzle 35, such an increase is accomplished by using multiple fluid channels in one nozzle. In this way a larger volume of fluid may be dispensed with the inventive nozzle, while maintaining a high reliability in terms of non-leakage. The number of fluid channels in the nozzle may of course be varied according to the needs of the specific application.

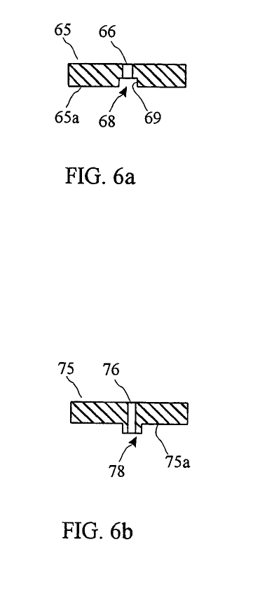

According to another embodiment of the present invention, the fluid channel is provided in an indentation in the bottom surface of the dispensing nozzle, which is shown in FIGS. 6a and 6b. The wall portion of the indentation forms an angle of 90° with the general extension of the nozzle. In the case of a nozzle with a high wetting angle, these 90° adds to the wetting angle of 90° or more of the material surface. Furthermore, this design gives a nozzle with improved functionality, especially for ink jet printers, where the nozzles may be damaged by contact with the paper to be printed. Since it is very easy for the paper to get in contact with the nozzle opening, the nozzle opening being the most sensitive part, this embodiment is well suited for inkjet printer applications, or similar applications with similar environments posing the possible hazard of damage to the nozzle.

According to yet another embodiment of the inventive dispensing nozzle, the fluid channel extends through a portion protruding from the bottom surface of the inventive dispensing nozzle, also shown in FIGS. 6a and 6b. Also in this embodiment, the wettability of the nozzle is improved Should a drop of the dispensed fluid stick to the protrusion, the drop will fall off the nozzle protrusion more easily than it would, if the outlet opening of the nozzle were not arranged on a portion protruding from the general plane of the nozzle bottom surface.

Further, the present invention teaches a method for manufacturing such dispensing nozzles. According to this method, dispensing nozzles having the features described above are manufactured. Moreover, the present invention also teaches the use of a moulding technique for manufacturing the dispensing nozzles. By using this technique, the choice of material is widened to include a very wide variety of e.g. polymeric materials. By choosing a polymeric material having suitable wettability properties, it is possible to obtain the desired material properties in at least some areas of the nozzle without having to use a subsequent surface treatment which is sometimes necessary with other techniques, e.g. plating techniques.

The mould itself may be manufactured by means of the same techniques, which are used for manufacturing substrates for plating, i.e. by curing a material by means of e.g. TV-light. The UV-light is transmitted through a curing mask in which the fluid channel or channels, in the case of a nozzle having e.g. an array of very fine fluid channels, are defined as holes in the mask. The curable material, which is deposited on a bottom substrate, is exposed to the UV-light through the mask, leaving the a negative form of the fluid channels cured, and the material which has not been cured is removed, leaving a fluid channel post or posts, of cured material after exposure. The possible length of the fluid channel is determined by the height of the fluid channel post or posts. There are of course other techniques that may be employed in producing the substrate, e.g. by providing materials that are curable under other circumstances.

In one embodiment of the present invention, the mould is made from silicon rubber. Silicon rubber is a material with desirable properties when used to make moulds, since it is very easy to strip the moulded material from a silicon rubber mould.

When the mould has been produced, a second mould is placed on top of the first mould with the fluid channel post (or posts in the case of producing more than one nozzle, or a nozzle having multiple openings), bearing on the fluid channel posts, and then the moulding material is introduced in a conventional way. The material is then cured, or simply allowed to cool or solidify, and the mould is removed

According to another embodiment of the present invention, the dispensing nozzle may be manufactured by multiple layer moulding. In this way, and by using materials with suitable characteristics, it is possible to predefine portions, especially of the fluid channel, which have different wetting angle characteristics.

According to another embodiment of the inventive manufacturing method, nozzles comprising an indentation surrounding the outlet opening of the fluid channel are produced. According to this method an upper mould is used having a shape corresponding to the negative shape of the indentation. The moulds are then brought together to form a moulding space, aligning the negative indentation and the fluid channel post, moulding material is supplied, and is allowed to cure or simply cool or solidify.

The present invention also teaches a similar manufacturing technique for manufacturing nozzles having a protrusion surrounding the outlet opening of the fluid channel. According to this method an upper mould is used having a shape corresponding to the negative shape of the protrusion. The moulds are then brought together to form a moulding space, aligning the negative indentation and the fluid channel post, moulding material is supplied, and is allowed to cure or simply cool or solidify.

In some instances, it may be advantageous to provide a mould made from a different material than silicon rubber, e.g. a metallic material or even a polymeric, or another material suitable for the specific purposes. The mould may be formed by means of a method that is suited for the mould material.

The invention also teaches the manufacturing of nozzles by means of plating on a plating substrate. This method is similar to the novel moulding technique in terms of mould manufacturing, apart from the fact that the nozzle base member including the fluid channel, is formed by any suitable plating method in which a conductive plating substrate is used. Since plating is a well known art, for instance from SE xxxx, no further discussion is given here.

For some combinations of mould material and moulding material, it may be necessary to provide the moulding surface of the mould or the moulds with a suitable surface treatment for facilitating the stripping of the finished nozzles from the mould. This is, however, also common knowledge in the art.

According to another aspect of the present invention, there is also provided a dispenser for dispensing minute volumes of fluid in a cost efficient way. According to this aspect of the present invention the dispenser comprises pressure generating member which may be comprised of a diaphragm of the type found for instance in loudspeakers which is reciprocated, thus generating a pressure pulse when moving in one direction, and generating a suction pulse when moving in the other direction. The pressure pulse is transmitted via a transmission fluid, e.g. air, in a pipe or hose, to a dispensing device according to the present invention and comprising the inventive dispensing nozzle, and used for providing dispensing action. According to the present invention, the pressure generating means of the dispenser performs this reciprocating motion with a predetermined frequency. In this way a cost efficient dispensing is obtained which deliver a continuous flow of droplets. Further, given the pressure of the pressure pulse delivered by the pressure generating member, the required starting pressure for initiating the dispensing of the fluid in the dispensing nozzle of the dispensing device, and the area of the outlet opening of the fluid channel of the inventive dispensing nozzle, dispensing of precise volumes of fluid is possible.

According to another embodiment of the present invention, the forward motion of the pressure generating member is performed with a first velocity, and the backward motion is performed with a second velocity which is lower than the first velocity. This is to ensure that no air or any other fluid with which the dispensing device or dispensing nozzle is in contact with, is sucked into the dispensing device during the return motion of the reciprocating pressure generating member.

Preferably, the dispenser is provided with mounting means for mounting a dispensing device according to the present invention.

One advantage with the dispenser according to the present invention is that the dispenser itself may be located remote from the dispensing device comprising the nozzle. Since air or other transmission fluids are used, it is sufficient to provide a conduit communicating the dispenser according to the present invention with the dispensing device comprising the inventive nozzle for transmitting the pressure pulses generated by the dispenser. It is, however, important to make sure that pressure losses are eliminated, since this will influence the dispensed volume in a substantial way, given the very small volumes to be handled and dispensed.

In one specific embodiment of one aspect of the present invention, mentioned above, a dispensing device in the form of a pipette tip is used in conjunction with a conventional pipette. If the normal suction function of the pipette is used for introducing the fluid to be dispensed into the fluid dispensing device, the volume introduced by means of the suction is for practical reasons preferably larger than the volume to be dispensed. Then the proper volume is then dispensed from the pipette tip. The pipette tip may then be discarded, another tip mounted to the pipette, and the procedure repeated. This dispensing procedure is the conventional way of dispensing fluids by means of pipettes in most applications. Thanks to the very cost efficient manufacturing method according to the present invention, it is possible to produce pipette tips capable of dispensing minute volumes, at a cost which is more or less the same as for ordinary pipette tips which are not capable of handling volumes which are smaller than one microlitre.

Thus, the objects set out initially are achieved by means of the different aspects of the present invention. Even though the principal field of application of the present invention is the biological or biochemical field, some embodiment of the present invention may be used with advantageous results in other fields of application. There are, of course, numerous ways for the artisan to vary and modify the present invention. For instance, the inventive dispensing member may be used with other dispensers than pipettes, and different materials may be used for the different embodiments of all of the aspects of the present invention. Although many such modifications and variations are conceivable for the person skilled in the art, they all fall within the scope of the present invention, which is solely defined by the appended claims.

1. Dispensing nozzle (15), comprising an essentially flat base member (17) having two essentially parallel surfaces, and having at least one fluid channel (16) with an inlet opening and an outlet opening, said channel being oriented substantially perpendicularly in relation to the general extension of the base member (15), wherein a surface surrounding at least one of said openings has a high wetting angle for the fluid to be dispensed, characterized in that the nozzle is essentially flat and has a top and a bottom surface, and in that the fluid channel (16) extends through the nozzle (15) from the upper surface to the lower surface, wherein said fluid channel (16) outlet opening is provided in an indentation on the bottom surface, or is arranged on a protrusion on the bottom surface.

2. Dispensing nozzle according to claim 1, wherein the fluid channel (16) has a cross-sectional area of 300 μm² to 0.1 mm².

3. The nozzle according to claim 1 or 2, wherein the indentation in the lower surface of the nozzle has a surface with low wettability.

4. The nozzle according to claim 1, wherein the outlet opening of the fluid channel is arranged on a protrusion on the bottom surface.

5. The nozzle according to claim 1 or 2, wherein the protruding area of the lower surface of the dispensing member has a surface with low wettability.

6. Dispensing member according to any of the claims 1 to 5, wherein the fluid channel has a circular cross section.

7. Dispensing member according to any of the claims 1 to 5, wherein the fluid channel is designed so that the ratio circumference/cross sectional area of the opening is as high as possible.

8. Dispensing member according to any of the preceding claims 1 to 5, wherein only the lower surface of the nozzle has a surface with low wettability.

9. Method for manufacturing a dispensing nozzle as claimed in claim 1, comprising the steps of providing the base member with a fluid channel having an inlet opening and an outlet with a cross sectional area in the range of 300 μm2 to 0.1 mm2, said channel being arranged substantially perpendicular in relation to the general extension of the dispensing nozzle, wherein the method further comprises the steps of providing at least a portion of the fluid channel surface of the nozzle with high wettability properties, and providing at least a portion of the surfaces of the dispensing member surrounding the dispensing opening with low wettability properties.

10. Method according to claim 9, wherein the method further comprises the steps of providing a portion which is indented in relation to the general extension of the lower surface of the dispensing member, and arranging the fluid channel so that it opens in said indentation.

11. Method according to claim 10, comprising the further step of providing at least a portion of the indented portion with low wettability surface characteristics.

12. Method according to claim 9, wherein the method further comprises the steps of providing a portion which protrudes from the general extension of the lower surface of the base member, and arranging the fluid channel so that it extends through, and opens on said protrusion.

13. Method according to claim 12, comprising the further step of providing at least a portion of the protruding area with low wettability surface characteristics.

14. Method according to any of the claims 9 to 13, comprising the step of providing a fluid channel with a substantially circular cross section.

15. Method according to any of the claims 9 to 13, comprising the step of providing a fluid channel which has a circumference which is as long as possible for a given fluid channel cross sectional area.

16. Method according to any of the claims 9 to 15, wherein the base member is manufactured by plating a layer of material on a plating substrate, said substrate comprising at least one post as a template for at least one fluid channel.

17. Method according to any of the claims 9 to 15, wherein the base member is manufactured by plating, on at plating substrate, a first layer of a material having a first desired material property, and subsequently plating, on the first plated layer, a second layer comprising a second material, said second material having a second desired material property, said plating substrate having at least one post as a template for at least one fluid channel

18. Method according to claim 17, wherein the first material property and the second material property are different wetting angles.

19. Method according to any of the claims 9 to 15, wherein the base member is manufactured by moulding of a suitable material in a substrate mould, said mould comprising at least one post as a template for at least one fluid channel.

20. Method according to any of the claims 9 to 15, wherein the base member is manufacturing by moulding two or more layers of material with different desired material properties in a substrate mould, said substrate mould comprising at least one post for forming at least one fluid channel.

21. Method according to claim 19 or 20, wherein the mould is made from a silicon rubber material.

22. Method according to any of the claims 19 to 21, wherein at least one of the moulded materials is a polymeric material.

23. Method according to any of the claims 19 to 21, wherein the desired material property is different wetting angles.

24. A pipette tip for use together with a dispenser, the dispenser comprising a base unit having mounting means and means for providing a dispensing action, the dispensing device being comprised of an elongate hollow body portion, having a first opening at a first end of the body portion, and a second opening at a second end of the body portion, the first end having mounting means mating with mounting means of the dispenser, wherein the dispensing device, in the second end of the conduit, is provided with a dispensing nozzle according to any of the claims 1 to 8.

25. Dispenser for dispensing minute volumes of fluid, wherein the dispensing action of the dispenser is provided by means of a pressure generating member which performs a reciprocating motion of a predetermined frequency generating a dispensing pressure, said dispensing device being provided with mounting means for mounting a pipette tip according to claim 24, and wherein a forward motion of the pressure generating member is performed with a first velocity, and the backward motion is performed with a second velocity which is lower than the first velocity.

26. Dispenser according to claim 25, wherein the dispenser is provided in a remote location relative to the dispensing device, and in fluid communication with said by means of a fluid connection through which cmoection pressure pulses are transmitted from the dispenser to the dispensing device, and ultimately to the dispensing nozzle.
